(19) United States
(12) Patent Application Publication
(10) Pub. No.: US 2015/0207344 A1
(43) Pub. Date: Jul. 23, 2015

(54) CONFIGURABLE HYBRID ENERGY STORAGE SYSTEM AND METHOD

(71) Applicant: General Electric Company, Schenectady, NY (US)

(72) Inventors: Ligong WANG, Erie, PA (US); Henry T. YOUNG, Erie, PA (US); Ajith K. KUMAR, Erie, PA (US); Ord A. RANDOLPH, Erie, PA (US)

(73) Assignee: General Electric Company, Schenectady, NY (US)

(21) Appl. No.: 14/157,700

(22) Filed: Jan. 17, 2014

(51) Int. Cl. H02J 7/00; B60K 6/28

(52) U.S. Cl. CPC H02J 7/0014; B60K 6/28; H02J 7/0054; Y10S 903/907

(57) ABSTRACT

An energy management module (EMM) configured to electrically interconnect at least one first energy storage unit, at least one second energy storage unit, and a power bus; and configured to select a mode of operation. Each first energy storage unit has a first permissible charge rate; each second energy storage unit has a second permissible charge rate less than the first permissible charge rate. Under an energy storage mode of operation, the EMM is configured to allocate electrical current from the power bus among the first and second energy storage units. Under an energy balance mode of operation, the EMM is configured to transfer electrical charge among the first energy storage unit(s) and the second energy storage unit(s). Under an energy discharge mode of operation, the EMM is configured to deliver electrical current from the first and second energy storage units to the power bus.

### BACKGROUND

1. Technical Field

Embodiments of the invention relate generally to energy storage systems. Other embodiments relate to methods and systems for managing power sources in hybrid vehicles that incorporate regenerative braking.

2. Discussion of Art

In order to comply with governmental emissions requirements for large off-highway mining vehicles (“OHVs”), such as the U.S. EPA Tier IV requirements, substantial enhancements of fuel efficiency will be required. One concept is to institute total regenerative braking.

In regenerative braking, braking motors convert the mechanical energy of a moving OHV into braking current, and a braking control circuit directs the braking current into a charge storage device (e.g., a battery or capacitor). Later, current is drawn from the charge storage device to power wheel motors (the same as, or different from, the braking motors) for accelerating the OHV. However, conventional OHV braking control circuits are configured to dump at least some of the braking current through large resistor banks (“braking grids”) where the braking energy is dissipated as waste heat. This has been the standard for OHV braking technology because to optimize size and cost, conventional energy storage systems have been designed just large enough to store the total energy of a design braking transient at the highest feasible voltage. For example, a design braking transient, for a 600 ton gross weight OHV coming to a complete stop from maximum rated speed on a downhill grade, might have peak power (current) up to 1.2 MW (e.g., 2000 A at 600 V), with total energy (possible charge) up to 120 MJ (333 A on a 600 VDC storage bus for 100 s). Thus, a 600 V energy storage system adequate to store 100% of the design braking energy (33.3 kWh) would need to support a peak charge rate of 2000 A or 6c (where “c” is a multiple of energy storage capacity in Ah) in order to handle the design peak braking power.

Conventional electrical energy storage technologies, developed for the consumer electric vehicle market, are not capable of supporting the high charge rates required for total regenerative braking of an OHV. Due to the various chemical and electrical properties of their constituent materials, conventional technologies that have satisfactory energy densities (sufficient to retain OHV braking energies within acceptable mass and volume) tend to have unacceptably low charge rates. Meanwhile, technologies with acceptable charge rates tend to have unacceptably high rates of “leakage” (self discharge). Thus, there is a design trade-off between energy storage/unit mass (“energy density”) and feasible charge rate. Between energy density and charge rate, energy density has been the preferred characteristic for design optimization because energy density directly contributes to vehicle weight. Thus, hybrid OHVs typically have incorporated resistor banks (“braking grids”) for dissipating as heat a portion of peak braking power that exceeds the allowable charge rate of the hybrid energy storage systems. The energy wasted through the braking grids results in higher-than-optimal emissions in order to operate the OHVs.

### BRIEF DESCRIPTION

In view of the above, an embodiment of the invention relates to a configurable hybrid energy storage system that can receive electrical energy from a regenerative braking system, store the electrical energy with less than a design rate of energy leakage, and release the electrical energy back to a driving motor.

According to aspects, a hybrid energy storage system (HESS) includes different energy storage units (ESUs), either multiple types of technologies or different configurations. The HESS is designed to capture electrical energy (charge) produced from braking and to deliver the captured charge for propulsion as needed. The HESS includes an energy management system (EMS) that is configured to implement at least one of a first method for capturing electrical energy in one or more of the ESUs during a braking transient, a second method for delivering electrical energy from one or more of the ESUs during a propulsion transient, and a third method for re-distributing charge among the ESUs during a steady state condition (not in a braking transient or propulsion transient).

According to aspects, the HESS is capable of capturing electrical energy at a charge current rate in excess of 6c, where a 1c rate means the discharge current will discharge the entire HESS storage in one hour.

In embodiments, an energy storage system includes an energy management module configured to electrically interconnect at least one first energy storage unit and at least one second energy storage unit with a power bus of a vehicle. The energy management module is configured to select among an energy storage mode of operation, an energy balance mode of operation, and an energy discharge mode of operation. Under the energy storage mode of operation, the energy management module receives electrical current from the power bus of the vehicle and allocates the electrical current among the at least one first energy storage unit and the at least one second energy storage unit. Under the energy balance mode of operation, the energy management module transfers electrical charge among the at least one first energy storage unit and the at least one second energy storage unit. Under the energy discharge mode of operation, the energy management module delivers electrical current to the power bus of the vehicle from at least one of the at least one first energy storage unit and the at least one second energy storage unit.

In aspects, a method is provided for operating an energy storage system connected to a power source and to a load. The method includes selecting one of an energy storage mode of operation, an energy balance mode of operation, or an energy discharge mode of operation. Under the energy storage mode of operation, the method includes receiving electrical current from the power source and allocating the electrical current among at least one first energy storage unit of the energy storage system and at least one second energy storage unit of the energy storage system, wherein the at least one first energy storage unit is of a first type having a first energy density, a first charge capacity, and a first permissible charge rate, and the at least one second energy storage unit is of a second type having a second energy density, a second charge capacity, and a second permissible charge rate that is less than the first permissible charge rate. Under the energy balance mode of operation, the method includes transferring electrical charge among the at least one first energy storage unit and the at least one second energy storage unit. Under the energy discharge mode of operation, the method includes delivering electrical current from among the first and second energy storage units to the load. In certain aspects, the method includes allocating electrical current among the first and second energy storage units according to the first and second permissible charge rates.

In another embodiment, an energy storage system comprises a first energy storage unit having a first permissible charge rate, a second energy storage unit having a second permissible charge rate that is less than the first permissible charge rate, and an energy management module configured to electrically interconnect the first and second energy storage units with a power bus and configured to select among at least first, second, and third modes of operation. Under the first mode of operation (e.g., an energy storage mode of operation), the energy management module is configured to allocate electrical current from the power bus among the first and second energy storage units. Under the second mode of operation (e.g., an energy balance mode of operation), the energy management module is configured to transfer electrical charge among the first energy storage unit and the second energy storage unit in anticipation of a next anticipated mode of operation. Under the third mode of operation (e.g., an energy discharge mode of operation), the energy management module is configured to deliver electrical current from the first and second energy storage units to the power bus.

### DRAWINGS

The present invention will be better understood from reading the following description of non-limiting embodiments, with reference to the attached drawings, wherein below:

FIG. 1 illustrates in schematic view a power system of a hybrid OHV;

FIG. 2 illustrates in schematic view an energy storage mode of operation in an OHV energy storage system according to an embodiment of the invention;

FIG. 3 illustrates in schematic view an energy balance mode of operation in the energy storage system according to FIG. 2;

FIG. 4 illustrates in schematic view an energy discharge mode of operation in the energy storage system according to FIG. 2;

FIG. 5 illustrates in schematic view an OHV energy storage system incorporating a charger unit according to another embodiment of the invention;

FIG. 6 is a flowchart illustration of a process for selecting a mode of operation of an energy storage system as shown in FIG. 2 or FIG. 5; and

FIG. 7 is a flowchart illustration of a process for determining what to do under an energy balance mode of operation of an energy storage system.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts, without duplicative description.

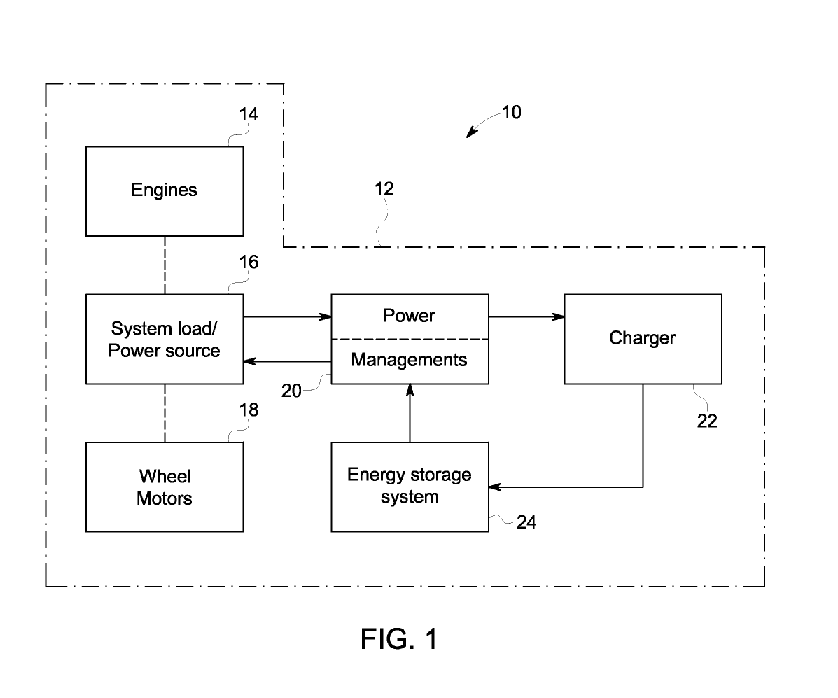

FIG. 1 illustrates in schematic view a hybrid OHV 10 that includes a frame 12 (shown in phantom line). (Although embodiments are illustrated in the context of OHVs, they are also applicable to vehicles more generally.) Mounted within the frame 12 are an engine/generator 14, a power bus 16, and wheel motors 18. The power bus 16 is connected, via a power management module 20, with a charger 22 and with an energy storage system 24 (e.g., a battery, a flywheel, a capacitor, or similar structures known to those of ordinary skill). In operation, the power management module 20 is controlled to operate in a storage mode (sending electrical power from the power bus 16 to the charger 22) or in a discharge mode (sending electrical power from the energy storage system 24 to the power bus 16).

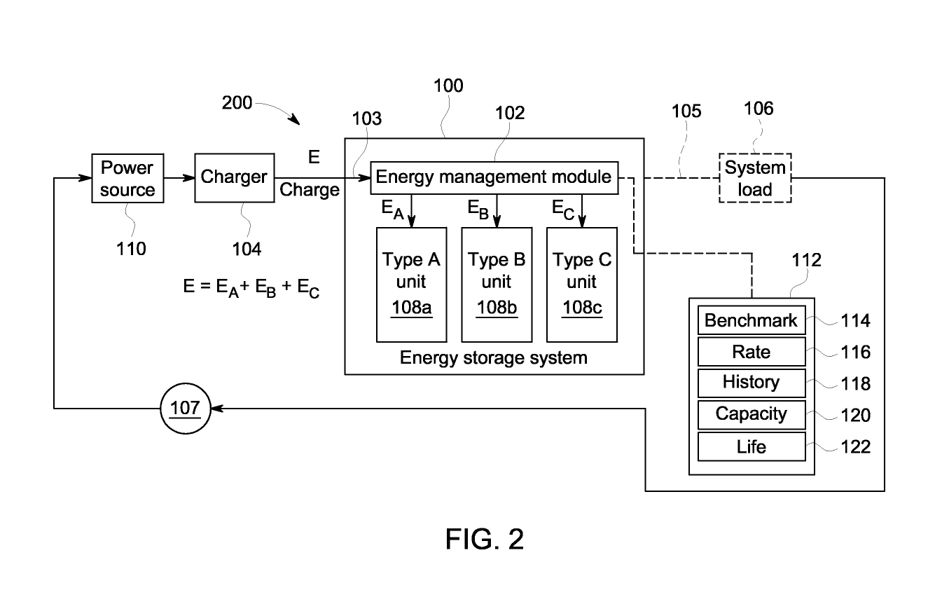

FIG. 2 illustrates in schematic view an energy storage mode of operation 200 in an OHV energy storage system 100 according to an embodiment of the invention. The energy storage system 100 includes an energy management module 102 that connects at a first external terminal 103 to a charger 104 and at a second external terminal 105 to a system load 106 (e.g., a power bus electrically connected with wheel motors 107 in driving mode) with energy storage units 108. (Three types of energy storage units 108a, 108b, 108c are shown in FIG. 2 for illustration purposes, however, embodiments of the invention are applicable to two types of energy storage units, or more than three types of energy storage units.) The charger 104 is powered from a power source 110 (e.g., the power bus electrically connected with a generator, or with the wheel motors 107 in braking mode). During the energy storage operation, the wheel motors are in braking mode so that the power source 110 is switched on while the system load 106 is switched off Thus, the energy management module 102 directs electrical current from the charger 104 into the various energy storage units 108. The energy management module 102 is configured to store and process various information 112 describing the energy storage units 108, including, for example, for each unit: a charge capacity benchmark 114; a permissible charge/discharge rate 116; a charge/discharge history 118; an estimated present charge capacity 120; and a charge cycle life expectancy 122.

The energy storage units 108, as shown in FIG. 2, include Type A, Type B, and Type C units (108a, 108b, 108c, respectively). By way of example, without limitation, the Type A units may be ultra-capacitors with 100 Ah total capacity and up to 10c (1000 A) charge rate (where a 1c rate means the discharge current will discharge the entire capacity of the energy storage device in one hour); while the Type B units may be Lithium-Titanate batteries with 200 Ah total capacity and up to 6c (1200 A) charge rate. During the energy storage operation, the energy management module 102 preferentially allocates 202 peak current of 2000 A among the different types of energy storage unit according to their respective charge rates, thus, for example, 900 A to the Type A units and 1100 A to the Type B units. However, the Types A, B, and C units may be any type of energy storage device, for example, lead acid cells with 100 Ah total capacity and 0.5C (50 A) charge rate; polymer lithium ion batteries; and/or fuel cells. For purposes of this exemplary embodiment, the type A units have a higher specific charge rate (“c”) than do the type B units. Thus, the type A units are relatively “high-c” units. It will be appreciated that permissible charge rate is a product of capacity and specific charge rate. Thus, in certain embodiments, the type A units are configured with sufficient charge capacity such that they have a higher permissible charge rate than do the type B units.

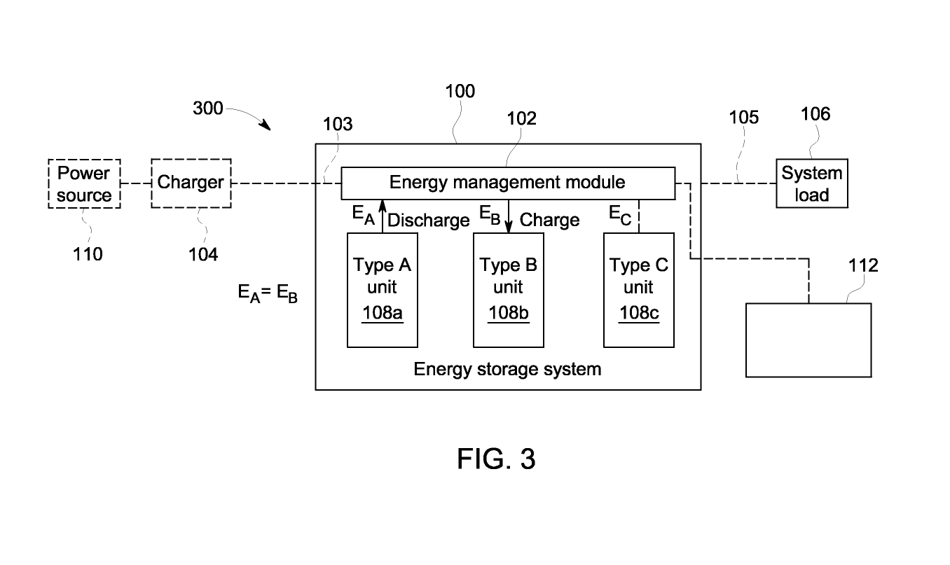

FIG. 3 illustrates in schematic view an energy balance mode of operation 300 in the energy storage system according to FIG. 2. During one aspect of the energy balance mode of operation 300, the energy management module 102 receives 302 electrical current from one type of the energy storage units (having a relatively higher permissible charge rate) and delivers 304 the electrical current to another type of the energy storage units (having a relatively lower permissible charge rate). For example, the energy management module 102 may receive electrical current from the relatively low capacity, high-c rate Type A energy storage units 108a, and deliver 304 the electrical current to the relatively high capacity, low-c rate Type B storage units 108b or even to very-low-c rate Type C storage units 108c. As a result, the energy storage units with the relatively higher permissible charge rate (e.g., the high-c rate Type A units) are made fully available to receive peak current in anticipation of a subsequent braking transient (energy storage mode of operation).

In another aspect of the energy balance mode of operation 300, the energy management module 102 may transfer electrical current among one type of the energy storage units (e.g., the Type A energy storage units 108a, or the Type B energy storage units 108b), in order to equalize unused charge capacity across these units. In another aspect of the energy balance mode of operation 300, the energy management module 102 may transfer electrical current from one type of the energy storage units, having a relatively lower specific charge rate (e.g., the Type B energy storage units 108b) to another type of the energy storage units having a relatively higher specific charge rate (e.g., to the Type A energy storage units 108a), in anticipation of a subsequent driving transient (energy discharge mode of operation). In another aspect of the energy balance mode of operation 300, the energy management module 102 may minimize electrical current to or from one or more of the energy storage units 108, based on charge/discharge history and cycle life expectancy of each unit.

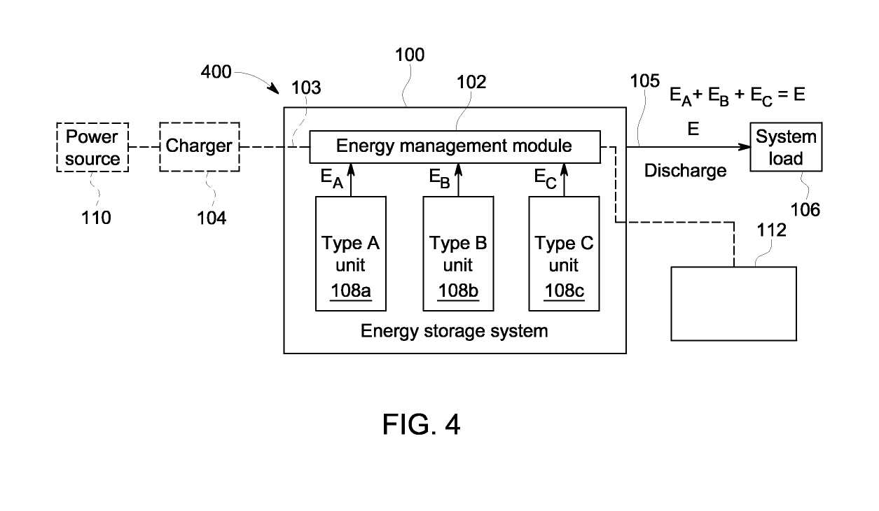

FIG. 4 illustrates in schematic view an energy discharge mode of operation 400 in the energy storage system according to FIG. 2. During the energy discharge mode of operation 400, the energy management module 102 draws 402 electrical current from all of the energy storage units 108. The energy management module 102 may allocate current draw 402 among the various energy storage units 108, according to their various permissible charge rates, charge capacities, states of charge (unused charged capacities), and cycle life expectancies. The energy management module 102 then delivers 404 the electrical current to the system load 106.

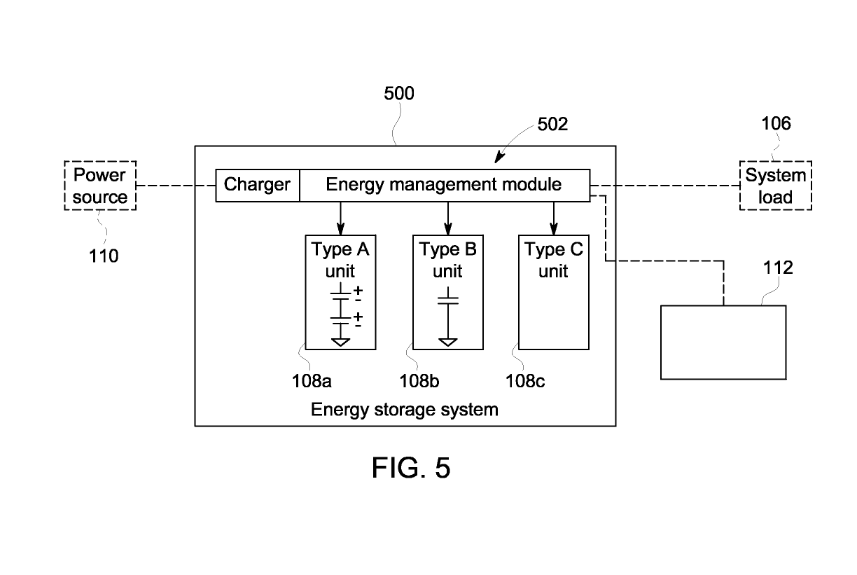

FIG. 5 illustrates in schematic view an OHV energy storage system 500 that incorporates an integrated charger unit and energy management module 502 according to another embodiment of the invention. In an energy storage mode of operation, the charger unit/energy management module 502 draws electrical current from the power source 110 and allocates the electrical current among energy storage units 108. In an energy balancing mode of operation the module 502 re-allocates electrical current among the energy storage units 108. In an energy discharge mode of operation the module 502 delivers electrical current from the energy storage units to a system load 106.

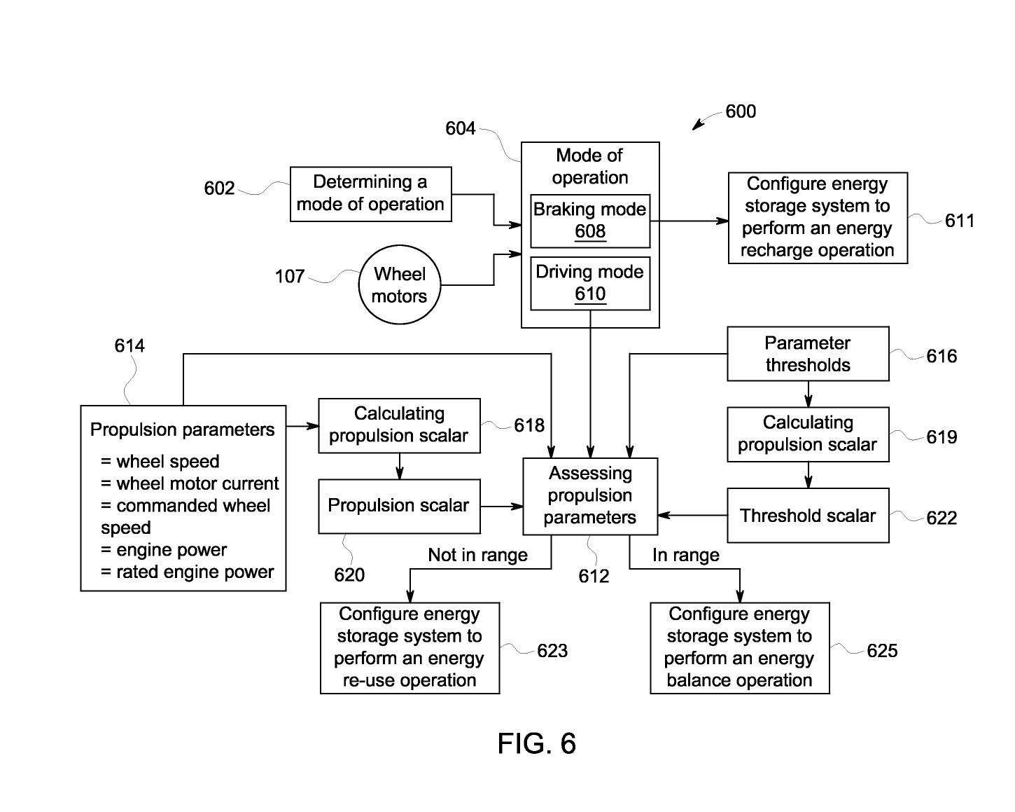

FIG. 6 is a flowchart illustration of a process 600 for selecting an operation to be performed by an energy storage system as shown in FIG. 2 or FIG. 5. The process 600 includes determining 602 a mode of operation 604 of the wheel motors 107 (e.g., a braking mode 608 or a driving mode 610).

In case the wheel motors 606 are operating in the braking mode 608 (as a power source 110), then the energy storage system is configured 611 to perform an energy storage mode of operation as shown, for example, in FIG. 2.

In case the wheel motors 606 are operating in the driving mode 610 (as a system load 106), then the process continues to assessing 612 propulsion parameters 614 (e.g., wheel speed; wheel motor current draw; commanded wheel speed; engine power; rated engine power) by comparison to parameter thresholds 616. For example, assessing 612 may include calculating 618 a dimensionless propulsion scalar 620, which would be compared to a threshold scalar 622 similarly calculated 619 from the parameter thresholds 616; alternatively, assessing 612 may be accomplished on a per-parameter basis.

Under a scalar comparison method of assessing 612, then in case the propulsion scalar 620 is sufficiently in excess of the threshold scalar 622, the energy storage system is configured 623 to perform an energy discharge mode of operation as shown, for example, in FIG. 4. On the other hand, under a per-parameter method of assessing 612, any out of range parameter causes the energy storage system to be configured 623 to perform the energy discharge mode of operation.

In case the wheel motors 606 are operating in the driving mode 610, and the propulsion scalar 620 is less than the threshold scalar 622 (or in case all propulsion parameters 616 are in-range), then the energy storage system is configured 625 to perform an energy balance mode of operation as shown, for example, in FIG. 3. In one aspect of the invention, the energy balance mode of operation is the default operation for the energy storage system 100 or 200.

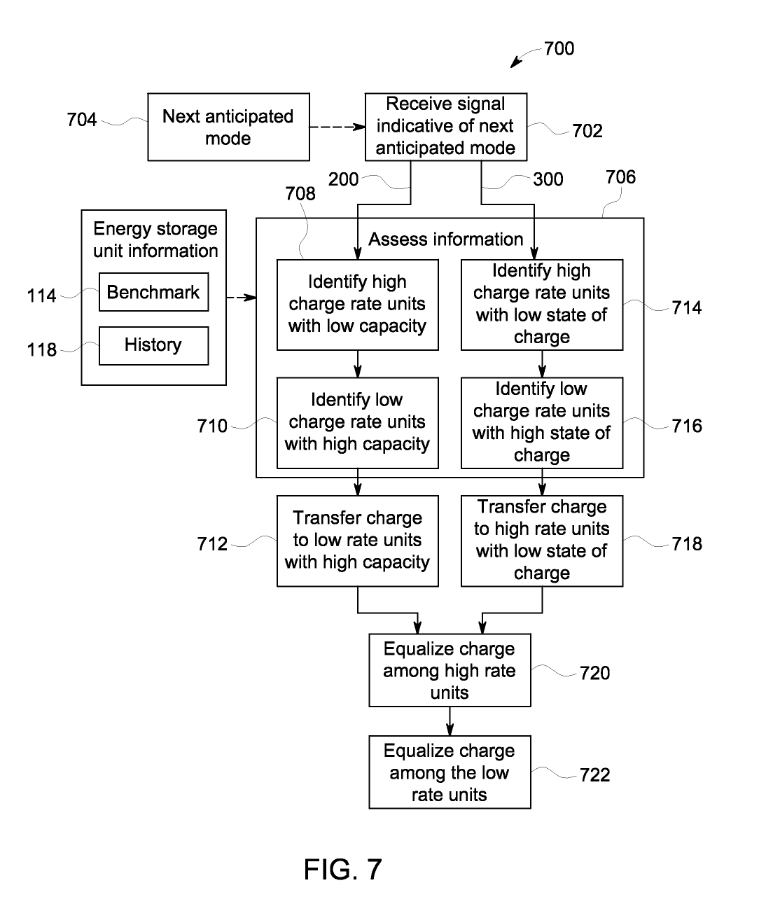

FIG. 7 is a flowchart of a process or method 700 by which the energy management module determines what to do in the energy balance mode of operation 300. First, the energy management module 102 receives 702 a signal indicative of a next anticipated mode of operation 704. In some embodiments, for example, a signal indicative of a next anticipated mode of operation may be provided from an operator input, e.g., a pedal or throttle interface. In other embodiments, as another example, a signal indicative of a next anticipated mode of operation may be provided from an autonomous navigation system, e.g., a position along a pre-planned route. Then, the energy management module 102 assesses 706 the information 112 related to the various energy storage units 108. If the next anticipated mode of operation 704 is an energy storage mode of operation 200, then, the energy management module 102 identifies 708 any of the energy storage units 108a that have relatively low present charge capacity 118 (high state of charge), identifies 710 any of the energy storage units 108b that have relatively high present charge capacity (low state of charge), and transfers 712 charge from the units 108a with high states of charge to the units 108b with low states of charge. On the other hand, if the next anticipated mode of operation 704 is an energy discharge mode of operation 400, then the energy management module 102 identifies 714 any of the energy storage units 108a that have relatively high present charge capacity 118 (low state of charge), identifies 716 other energy storage units 108b having relatively low present charge capacity 118 (high state of charge), and transfers 718 charge to the units 108a with low states of charge from the units 108b with high states of charge. Additionally, the energy management module 102 equalizes 720 states of charge among the energy storage units 108a and equalizes 722 states of charge among the energy storage units 108b. Typically, identification and equalization of energy storage units states of charge is accomplished with reference to each unit's benchmark charge capacity 114 and charge/discharge history 118.

Thus, in embodiments, an energy storage system includes an energy management module configured to electrically interconnect at least one first energy storage unit and at least one second energy storage unit with a power bus of a vehicle. The energy management module is configured to select among an energy storage mode of operation, an energy balance mode of operation, and an energy discharge mode of operation. Under the energy storage mode of operation, the energy management module receives electrical current from the power bus of the vehicle and allocates the electrical current among the at least one first energy storage unit and the at least one second energy storage unit. Under the energy balance mode of operation, the energy management module transfers electrical charge among the at least one first energy storage unit and the at least one second energy storage unit. Under the energy discharge mode of operation, the energy management module delivers electrical current to the power bus of the vehicle from at least one of the at least one first energy storage unit and the at least one second energy storage unit. In certain embodiments, the energy storage system is mounted in the vehicle; each of the at least one first energy storage unit includes a first type of energy storage unit having a first energy density, a first charge capacity, and a first permissible charge rate; and each of the at least one second energy storage unit includes a second type of energy storage unit having a second energy density, a second charge capacity, and a second permissible charge rate that is less than the first permissible charge rate. The energy management module configured to at least one of allocate, transfer, or deliver electrical current or charge according to any or all of the energy densities, charge capacities, or permissible charge rates of the first and second types of energy storage units. In some embodiments, the energy storage system also includes at least one third energy storage unit of a third type having a third energy density, a third charge capacity, and a third permissible charge rate, any of these being different from those of the first and second energy storage units. In embodiments, the energy management module is configured to allocate electrical current among the first and second energy storage units according to the first and second permissible charge rates. In embodiments, the at least one first energy storage unit includes plural first energy storage units, and the energy management module is configured to transfer electrical charge among the first energy storage units to equalize state of charge in each of the first energy storage units. In embodiments, the at least one second energy storage unit includes plural second energy storage units, and the energy management module is configured to transfer electrical charge among the second energy storage units to equalize state of charge in each of the second energy storage units. In certain embodiments, the energy management module is configured to transfer electrical charge among the at least one first energy storage unit and the at least one second energy storage unit according to a next anticipated mode of operation. For example, the energy management module is configured to transfer electrical charge from at least one first energy storage unit to at least one second energy storage unit in anticipation of an energy storage mode of operation. As another example, the energy management module is configured to transfer electrical charge from at least one second energy storage unit to at least one first energy storage unit in anticipation of an energy discharge mode of operation. In certain embodiments, the energy management module is configured to receive a signal indicative of the next anticipated mode of operation.

In aspects, a method is provided for operating an energy storage system connected to a power source and to a load. The method includes selecting one of an energy storage mode of operation, an energy balance mode of operation, or an energy discharge mode of operation. Under the energy storage mode of operation, the method includes receiving electrical current from the power source and allocating the electrical current among at least one first energy storage unit of the energy storage system and at least one second energy storage unit of the energy storage system, wherein the at least one first energy storage unit is of a first type having a first energy density, a first charge capacity, and a first permissible charge rate, and the at least one second energy storage unit is of a second type having a second energy density, a second charge capacity, and a second permissible charge rate that is less than the first permissible charge rate. Under the energy balance mode of operation, the method includes transferring electrical charge among the at least one first energy storage unit and the at least one second energy storage unit. Under the energy discharge mode of operation, the method includes delivering electrical current from among the first and second energy storage units to the load. In certain aspects, the method includes allocating electrical current among the first and second energy storage units according to the first and second permissible charge rates. In certain aspects, the at least one first energy storage unit comprises plural first energy storage units, and, under the energy balance mode of operation, the method may include transferring electrical charge among the first energy storage units to equalize state of charge in each of the first energy storage units. Also, the at least one second energy storage unit may comprise plural second energy storage units, and, under the energy balance mode of operation, the method may include transferring electrical charge among the second energy storage units to equalize state of charge in each of the second energy storage units. The method also may include, under the energy balance mode of operation, transferring electrical charge among the at least one first energy storage unit and the at least one second energy storage unit according to a next anticipated mode of operation. For example, transferring electrical charge from the at least one first energy storage unit to the at least one second energy storage unit in anticipation of an energy storage mode of operation. As another example, transferring electrical charge from the at least one second energy storage unit to the at least one first energy storage unit in anticipation of an energy discharge mode of operation. In certain aspects, the method includes receiving a signal indicative of a next anticipated mode of operation.

In another embodiment, a method of operating an energy storage system connected to a power source and to a load comprises selecting an energy storage mode of operation, selecting an energy balance mode of operation, and selecting an energy discharge mode of operation. That is, at different times, the method involves operation in the energy storage mode, the energy balance mode, and the energy discharge mode. Under the energy storage mode of operation, the method comprises receiving electrical current from the power source and allocating the electrical current among at least one first energy storage unit of the energy storage system and at least one second energy storage unit of the energy storage system, wherein the at least one first energy storage unit is of a first type having a first energy density, a first charge capacity, and a first permissible charge rate, and the at least one second energy storage unit is of a second type having a second energy density, a second charge capacity, and a second permissible charge rate that is less than the first permissible charge rate. Under the energy balance mode of operation, the method comprises transferring electrical charge among the at least one first energy storage unit and the at least one second energy storage unit. Under the energy discharge mode of operation, the method comprises delivering electrical current from among the first and second energy storage units to the load.

In another embodiment, an energy storage system comprises a first energy storage unit having a first permissible charge rate, a second energy storage unit having a second permissible charge rate that is less than the first permissible charge rate, and an energy management module configured to electrically interconnect the first and second energy storage units with a power bus. The energy management module is also configured to select among at least first, second, and third modes of operation. (For example, at different times, the energy management operates in the first mode of operation, the second mode of operation, and the third mode of operation.) Under the first mode of operation (e.g., an energy storage mode of operation), the energy management module is configured to allocate electrical current from the power bus among the first and second energy storage units. Under the second mode of operation (e.g., an energy balance mode of operation), the energy management module is configured to transfer electrical charge among the first energy storage unit and the second energy storage unit in anticipation of a next anticipated mode of operation. Under the third mode of operation (e.g., an energy discharge mode of operation), the energy management module is configured to deliver electrical current from the first and second energy storage units to the power bus.

In another embodiment, a vehicle (e.g., an OHV) comprises a vehicle frame, an energy storage system connected to the vehicle frame, and at least two wheel motors connected to the vehicle frame. The energy storage system comprises a first energy storage unit having a first permissible charge rate, a second energy storage unit having a second permissible charge rate that is less than the first permissible charge rate, and an energy management module configured to electrically interconnect the first and second energy storage units with a power bus. The energy management module is also configured to select among at least first, second, and third modes of operation. (For example, at different times, the energy management operates in the first mode of operation, the second mode of operation, and the third mode of operation.) Under the first mode of operation (e.g., an energy storage mode of operation), the energy management module is configured to allocate electrical current from the power bus among the first and second energy storage units. Under the second mode of operation (e.g., an energy balance mode of operation), the energy management module is configured to transfer electrical charge among the first energy storage unit and the second energy storage unit in anticipation of a next anticipated mode of operation. Under the third mode of operation (e.g., an energy discharge mode of operation), the energy management module is configured to deliver electrical current from the first and second energy storage units to the power bus. The at least two wheel motors are electrically coupled to the power bus for receiving the electrical current delivered by the energy management module in the third mode of operation and for providing the electrical current to the power bus in the first mode of operation. The vehicle has a gross unloaded mass of at least twenty tonnes (1 tonne=1 metric ton=1000 kg). The first energy storage unit has a first permissible charge rate and the second energy storage unit has a second permissible charge rate that is greater than the first permissible charge rate; the first permissible charge rate is at least two hundred ampere. The first and second energy storage units have a combined charge capacity of at least two kilowatt-hours. As should be appreciated, in such an embodiment of a vehicle, the energy storage system is configured, and has a capacity to accommodate, a very large size of vehicle, such as a mining dump truck or other large OHV, and such vehicles will thereby have a greater degree of fuel economy (use less fuel for the same haulage operations) than if the same vehicles were not so equipped.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable one of ordinary skill in the art to practice embodiments of the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal language of the claims.

As used herein, an element or step recited in the singular and proceeded with the word “a” or “an” should be understood as not excluding plural of the elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described embodiments, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An energy storage system comprising:
an energy management module configured to electrically interconnect at least one first energy storage unit and at least one second energy storage unit with a power bus of a vehicle, the energy management module is configured to select among an energy storage mode of operation, an energy balance mode of operation, and an energy discharge mode of operation;
wherein under the energy storage mode of operation, the energy management module is configured to receive electrical current from the power bus of the vehicle and allocate the electrical current among the at least one first energy storage unit and the at least one second energy storage unit; under the energy balance mode of operation, the energy management module is configured to transfer electrical charge among the at least one first energy storage unit and the at least one second energy storage unit; and under the energy discharge mode of operation, the energy management module is configured to deliver electrical current to the power bus of the vehicle from at least one of the at least one first energy storage unit and the at least one second energy storage unit.

2. The energy storage system as claimed in claim 1, mounted in the vehicle, wherein:
each of the at least one first energy storage unit comprises a first type of energy storage unit having a first energy density, a first charge capacity, and a first permissible charge rate; and
each of the at least one second energy storage unit comprises a second type of energy storage unit having a second energy density, a second charge capacity, and a second permissible charge rate that is less than the first permissible charge rate;
wherein the energy management module is configured to at least one of allocate, transfer, or deliver at least one of electrical current or charge according to any or all of the energy densities, charge capacities, or permissible charge rates of the first and second types of energy storage units.

3. The energy storage system as claimed in claim 2, further comprising at least one third energy storage unit of a third type having a third energy density, a third charge capacity, and a third permissible charge rate, wherein one or more of the third energy density, the third charge capacity, and the third permissible charge rate are different from those of the first and second energy storage units.

4. The energy storage system as claimed in claim 2, wherein the energy management module is configured to allocate electrical current among the first and second energy storage units according to the first and second permissible charge rates.

5. The energy storage system as claimed in claim 1, wherein the at least one first energy storage unit comprises plural first energy storage units, and wherein the energy management module is configured to transfer electrical charge among the first energy storage units to equalize state of charge in each of the first energy storage units.

6. The energy storage system as claimed in claim 1, wherein the at least one second energy storage unit comprises plural second energy storage units, and wherein the energy management module is configured to transfer electrical charge among the second energy storage units to equalize state of charge in each of the second energy storage units.

7. The energy storage system as claimed in claim 1, wherein the energy management module is configured to transfer electrical charge among the at least one first energy storage unit and the at least one second energy storage unit according to a next anticipated mode of operation.

8. The energy storage system as claimed in claim 7, wherein the energy management module is configured to transfer electrical charge from at least one first energy storage unit to at least one second energy storage unit in anticipation of the energy storage mode of operation.

9. The energy storage system as claimed in claim 7, wherein the energy management module is configured to transfer electrical charge from at least one second energy storage unit to at least one first energy storage unit in anticipation of the energy discharge mode of operation.

10. The energy storage system as claimed in claim 7, wherein the energy management module is configured to receive a signal indicative of the next anticipated mode of operation.

11. A method of operating an energy storage system connected to a power source and to a load, the method comprising:
selecting one of an energy storage mode of operation, an energy balance mode of operation, or an energy discharge mode of operation;
under the energy storage mode of operation, receiving electrical current from the power source and allocating the electrical current among at least one first energy storage unit of the energy storage system and at least one second energy storage unit of the energy storage system, wherein the at least one first energy storage unit is of a first type having a first energy density, a first charge capacity, and a first permissible charge rate, and the at least one second energy storage unit is of a second type having a second energy density, a second charge capacity, and a second permissible charge rate that is less than the first permissible charge rate;
under the energy balance mode of operation, transferring electrical charge among the at least one first energy storage unit and the at least one second energy storage unit; and
under the energy discharge mode of operation, delivering electrical current from among the first and second energy storage units to the load.

12. The method as claimed in claim 11, wherein under the energy storage mode of operation, the electrical current is allocated among the first and second energy storage units according to the first and second permissible charge rates.

13. The method as claimed in claim 11, wherein the at least one first energy storage unit comprises plural first energy storage units, and wherein under the energy balance mode of operation, the method further comprises transferring electrical charge among the first energy storage units to equalize state of charge in each of the first energy storage units.

14. The method as claimed in claim 11, wherein the at least one second energy storage unit comprises plural second energy storage units, and wherein under the energy balance mode of operation, the method further comprises transferring electrical charge among the second energy storage units to equalize state of charge in each of the second energy storage units.

15. The method as claimed in claim 11, wherein under the energy balance mode of operation, the electrical charge is transferred among the at least one first energy storage unit and the at least one second energy storage unit according to a next anticipated mode of operation.

16. The method as claimed in claim 15, wherein under the energy balance mode of operation, the electrical charge is transferred from the at least one first energy storage unit to the at least one second energy storage unit in anticipation of the energy storage mode of operation.

17. The method as claimed in claim 15, wherein under the energy balance mode of operation, the electrical charge is transferred from the at least one second energy storage unit to the at least one first energy storage unit in anticipation of the energy discharge mode of operation.

18. The method as claimed in claim 15, further comprising receiving a signal indicative of the next anticipated mode of operation.

19. An energy storage system comprising:
a first energy storage unit having a first permissible charge rate;
a second energy storage unit having a second permissible charge rate that is less than the first permissible charge rate; and
an energy management module configured to electrically interconnect the first and second energy storage units with a power bus and configured to select among at least first, second, and third modes of operation,
wherein, under the first mode of operation, the energy management module is configured to allocate electrical current from the power bus among the first and second energy storage units; under the second mode of operation, the energy management module is configured to transfer electrical charge among the first energy storage unit and the second energy storage unit in anticipation of a next anticipated mode of operation; and, under the third mode of operation, the energy management module is configured to deliver electrical current from the first and second energy storage units to the power bus.

20. A vehicle comprising:
a vehicle frame;
an energy storage system as claimed in claim 19 connected to the vehicle frame; and
at least two wheel motors connected to the vehicle frame and electrically coupled to the power bus for receiving the electrical current delivered by the energy management module in the third mode of operation and for providing the electrical current to the power bus in the first mode of operation;
wherein the vehicle has a gross unloaded mass of at least twenty tonnes;
wherein the first energy storage unit has a first permissible charge rate and the second energy storage unit has a second permissible charge rate that is greater than the first permissible charge rate, the first permissible charge rate being at least two hundred ampere; and
the first and second energy storage units have a combined charge capacity of at least two kilowatt-hours.
